(19) United States
(12) Patent Application Publication
(10) Pub. No.: US 2018/0246051 A1
(43) Pub. Date: Aug. 30, 2018

(54) LIQUID INTRUSION DETECTION DEVICE

(71) Applicant: OMRON Corporation, Kyoto (JP)

(72) Inventors: Kenji MATSUOKA, Moriyama-shi (JP); Takashi MURAMATSU, Fukuchiyama-shi (JP)

(73) Assignee: OMRON Corporation, Kyoto (JP)

(21) Appl. No.: 15/814,419

(22) Filed: Nov. 16, 2017

(30) Foreign Application Priority Data
Feb. 24, 2017 (JP) 2017-033435

(51) Int. Cl. G01N 27/12

(52) U.S. Cl. CPC G01N 27/12

(57) ABSTRACT

To ensure sufficient time for a user to take measures against a failure of a sensor before a liquid intrudes into the sensor and the sensor fails. A liquid intrusion detection device includes an intrusion detection circuit which detects a resistance value between a plurality of detection wires disposed inside a cable outputting an output value from a sensor, and a liquid intrusion determination unit which transmits a detection result to an external device in response to a resistance value detection result.

### CROSS-REFERENCE TO RELATED APPLICATION

This application claims the priority benefit of Japan application Ser. No. 2017-033435, filed on Feb. 24, 2017. The entirety of the above-mentioned patent application is hereby incorporated by reference herein and made a part of this specification.

### BACKGROUND

### Technical Field

The disclosure relates to a liquid intrusion detection device which detects whether a liquid intrudes into a sensor.

### p Description of Related Art

Up to now, a technique for preventing intrusion of a liquid into a device or the like has been disclosed. For example, Japanese Unexamined Patent Application Publication No. 2014-172273 discloses an electronic device having improved water resistance and a manufacturing method thereof.

Specifically, a proximity sensor, which is an electronic device, includes a ring cord. The ring cord includes a cable which has a core wire and a covering material and in which the core wire extends from an end portion of the covering material toward an electronic component in a longitudinal direction, and a ring member which is formed to cover the end portion of the covering material by injection molding. The end portion of the covering material and the ring member are welded to each other.

Thus, it is possible to prevent formation of a moisture intrusion path at a bonding surface between the end portion of the covering material and the ring member.

Further, a technique of detecting whether a liquid intrudes into a device or the like and predicting a failure of the device is disclosed. For example, Japanese Unexamined Patent Application Publication No. 64-43935 discloses a switch including a liquid intrusion detection switch which has a detection contact electrically short-circuited and turned on by the liquid when a liquid intrudes into a switch casing, and a failure prediction detection circuit which outputs a failure prediction signal at a time at which the detection contact of the liquid intrusion detection switch is turned on.

Further, in a sensor which measures a single physical amount and is represented as a proximity sensor, there is a case in which a failure occurs due to intrusion of a liquid into the sensor.

For example, even when a configuration disclosed in the related art is applied to a sensor, the following problem may arise.

In a configuration in which a liquid intrusion detection switch is disposed inside the same casing as a sensor, there is a possibility that the sensor may fail at a time at which the intrusion of a liquid is detected when the liquid intrudes into the casing.

### SUMMARY

According to an aspect of the disclosure, there is provided a liquid intrusion detection device including: a plurality of metal wires which are disposed inside a cable outputting an output value from a sensor measuring a single physical amount; a resistance value detection unit which detects a resistance value between the metal wires; and a communication unit which transmits a resistance value detection result to an external device in response to the resistance value detection result.

### BRIEF DESCRIPTION OF THE DRAWINGS

FIG. 1 is a block diagram showing a main configuration of a liquid intrusion detection device according to an embodiment.

FIG. 2A is a diagram showing an outline of a configuration of a sensor system according to an embodiment.

FIG. 2B is an enlarged view of a connection region R of a cable and a sensor shown in FIG. 2A.

FIG. 3 is a diagram showing an example of an intrusion detection circuit according to an embodiment.

FIG. 4 is a diagram showing an example of a cross-section of a cable according to an embodiment.

FIG. 5 is a flowchart showing an example of a flow of a process of the liquid intrusion detection device according to an embodiment.

FIG. 6 is a diagram showing an example of a correlation between an output voltage value of an intrusion detection circuit and an insulation resistance value between detection wires 11 according to an embodiment.

### DESCRIPTION OF THE EMBODIMENTS

The disclosure realizes a liquid intrusion detection device capable of ensuring sufficient time for a user to take measures against a failure of a sensor before a liquid intrudes into the sensor and the sensor fails.

In one embodiment, there is provided a liquid intrusion detection device including: a plurality of metal wires which are disposed inside a cable outputting an output value from a sensor measuring a single physical amount; a resistance value detection unit which detects a resistance value between the metal wires; and a communication unit which transmits a resistance value detection result to an external device in response to the resistance value detection result.

According to the above-described configuration, it is possible for a user to be notified of the intrusion of a liquid into the cable from the resistance value between the metal wires. Thus, the user can recognize whether the liquid intrudes into the cable.

As for the intrusion of the liquid into the sensor, in many cases, the liquid intrudes into the cable and the liquid intrudes into the sensor. For that reason, the user can recognize the intrusion of the liquid into the sensor and a failure of the sensor which may happen in the future in advance by checking whether the liquid intrudes into the cable.

For example, compared to a configuration in which electrodes are formed on an electronic board inside a sensor and a resistance value between the electrodes is detected, in the above-described configuration, it is possible to ensure sufficient time for a user to take measures against a failure of the sensor before the liquid intrudes into the sensor and the sensor fails. For that reason, the user can recognize the sensor in which the liquid intrudes into the cable as a replacement target sensor. Then, the user can prepare a preventive maintenance plan for replacing the sensor and stop a production line having the sensor for the maintenance. Thus, the user can avoid a sudden stop of the production line due to the failure of the sensor caused by the intrusion of the liquid.

In the liquid intrusion detection device according to an embodiment, the resistance value detection unit is connected to the plurality of metal wires at an end side of the cable opposite to an end side of the cable connected to the sensor.

According to the above-described configuration, the metal wire and the resistance value detection unit are connected to each other at the end of the cable opposite to the end of the cable connected to the sensor. For that reason, it is possible to prevent an intrusion of the liquid into the sensor along the metal wires in comparison to a configuration in which the resistance value detection unit is disposed inside the sensor.

In the liquid intrusion detection device according to an embodiment, the cable includes an outer sheath covering the cable and an inner sheath covering an output wire outputting an output value from the sensor disposed inside the cable, and the metal wires are disposed between the outer sheath and the inner sheath.

According to the above-described configuration, it is possible to detect the intrusion of the liquid into the outer sheath.

In the liquid intrusion detection device according to an embodiment, the cable includes an absorbing member that absorbs a liquid on the periphery of the metal wire.

According to the above-described configuration, when the liquid intrudes into the cable, the absorbing member absorbs the intruding liquid. For that reason, the resistance value between the metal wires changes in response to a degree (amount) of the liquid absorbed in the absorbing member. That is, when the absorbing member is disposed between the metal wires, the liquid intruding into the cable can be led between the metal wires.

In the liquid intrusion detection device according to an embodiment, a resistance value detection circuit detecting a resistance value between the metal wires includes a Wheatstone bridge corresponding to a signal amplification circuit.

According to the above-described configuration, since the Wheatstone bridge is used, an amplification signal output voltage of a liquid detection unit is proportional to a resistance value (an insulation resistance value) in response to a degree of intrusion of the liquid and changes like an analog signal. For that reason, the communication unit can reliably transmit a resistance value detection result to the external device in response to an accurate detection result.

In the liquid intrusion detection device according to an embodiment, the sensor is a proximity sensor.

An environment in which the proximity sensor is provided may be an environment in which the liquid is scattered. Thus, a possibility of the intrusion of the liquid into the sensor increases.

According to the above-described configuration, it is possible to realize the liquid intrusion detection device as the proximity sensor having a high possibility of intrusion of the liquid into the sensor.

In the liquid intrusion detection device according to an embodiment, the communication unit transmits the resistance value detection result to the external device by a communication method in which the amount of communication data is larger than binary data.

According to the above-described configuration, numerical data and the like can be communicated in comparison with a configuration in which only binary data such as on/off information can be communicated.

Further, for example, the communication method in which the amount of communication data is larger than that of binary data is an IO-Link communication method. By using the IO-Link communication method, compatibility with an external device using the IO-Link communication method can be enhanced.

According to an embodiment, there is an effect of the user being able to check whether a liquid intrudes into the cable of the sensor.

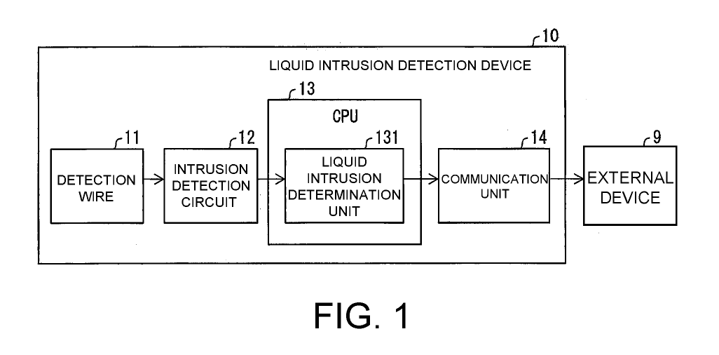

Hereinafter, an embodiment will be described with reference to FIGS. 1 to 6.

### (Outline of Sensor System 100)

The sensor system 100 according to the embodiment includes a liquid intrusion detection device 10 which detects whether a liquid intrudes into a cable 2 connected to a sensor 1 measuring a single physical amount, and transmits a detection result to an external device 9 in response to the detection result. Thus, a user can recognize whether the sensor 1 fails in advance by detecting the intrusion of the liquid into the cable 2. Additionally, in the embodiment, an example in which the liquid intruding into the sensor 1 is water will be mainly described, but an oil, a coolant, and the like which are used in a use environment of the sensor 1 can be exemplified as other liquids.

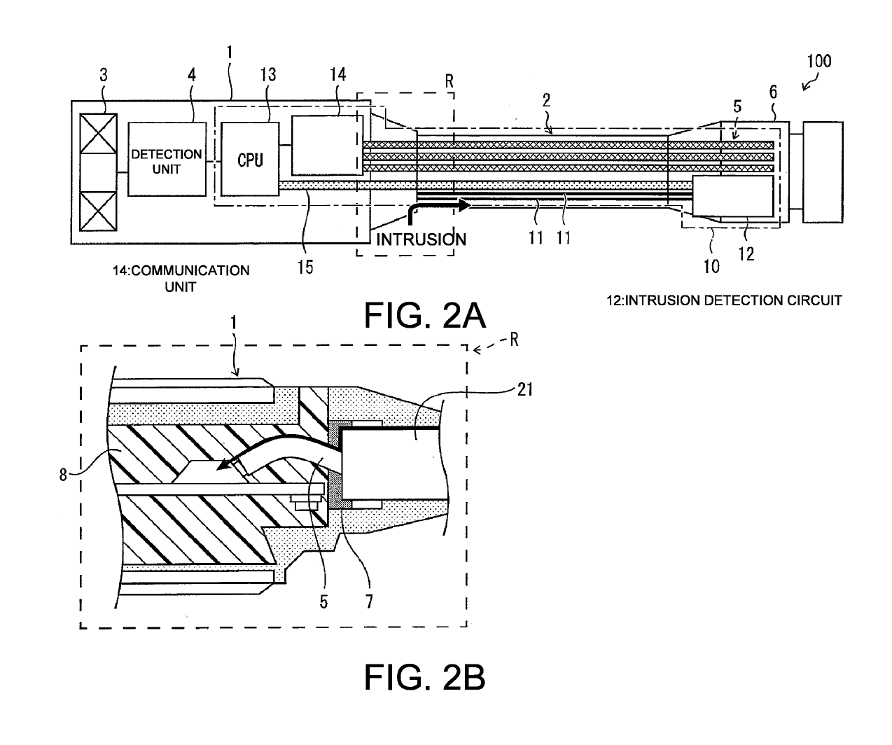

FIG. 2A is a diagram showing an outline of a configuration of the sensor system 100. As shown in FIG. 2A, the sensor system 100 includes the sensor 1, the cable 2, and a relay connector 6.

The sensor 1 includes a detection element 3, a detection unit 4, a CPU 13, and a communication unit 14. The sensor 1 is, for example, a proximity sensor.

An environment provided with the proximity sensor can be an environment in which a liquid is scattered. Thus, a possibility of the intrusion of the liquid into the sensor is increased. According to the above-described configuration, it is possible to realize a liquid intrusion detection device for a proximity sensor having a high possibility of intrusion of a liquid into the sensor.

The detection element 3 is, for example, a detection coil. When a metallic body corresponding to a detection target exists within a detectable range of the proximity sensor, a supply of an exciting current to the detection element 3 (the detection coil) is interrupted. Then, a magnetic field around the metallic body (a magnetic field generated by the detection coil) changes. As a result, an eddy current is generated in the metallic body. Since a magnetic flux generated by the eddy current passes through the detection coil, an induced voltage is generated in the detection coil. When a predetermined time elapses from a time point at which the supply of the exciting current to the detection coil is interrupted by the induced voltage, the induced voltage is mainly used as a voltage across both ends of the detection coil. That is, it is possible to detect the existence of or a position of the detection target by comparing a voltage across both of the ends of the detection coil with a threshold value.

The detection unit 4 converts the voltage across both of the ends of the detection coil into a voltage detection signal and transmits the signal to the CPU 13.

Furthermore, the sensor 1 is not particularly limited to the proximity sensor and may be, for example, a photoelectric sensor or the like. The detection element 3 detects a physical amount of the detection target and transmits a detection value to the detection unit 4. The detection unit 4 converts the detection value of the detection target into an electric signal and transmits the electric signal to the CPU 13.

The CPU 13 outputs a determination result of a detection signal of the detection unit 4 and an output value of the sensor 1 to the external device 9 via the communication unit 14 and a cord 5. Further, the CPU 13 outputs a detection result of a resistance value or the like to the external device 9 in response to a signal indicating a resistance value received from an intrusion detection circuit (a resistance value detection unit) 12 via the communication unit 14 and the cord 5. For example, when the sensor 1 includes a display device, the CPU 13 may display a detection result of the detection signal from the detection unit 4, a sensor output value, and a detection result (a determination result) in response to a signal received from the intrusion detection circuit 12 on the display device.

The communication unit 14 communicates with the external device 9 in accordance with an instruction of the CPU 13.

In other words, a processing unit which processes the sensing result of the sensor 1 and transmits the sensing result by communication and a processing unit which processes the signal received from the intrusion detection circuit 12 and transmits the signal by communication can be expressed as being formed on the same board (the CPU 13).

According to the above-described configuration, the processing unit which processes the detection result of the resistance value and transmits the detection result by communication can be formed on the same board as the processing unit which processes the sensing result of the sensor and transmits the sensing result by communication.

Further, the sensor 1 may include a protection circuit which electrically protects the CPU 13 by eliminating a signal noise and preventing a reverse connection, and a casing which forms an outermost shell of the sensor 1 and protects the inside of the sensor 1.

The relay connector 6 is connected to the external device 9, a power source, a signal wire, a ground (earth), and the like. The relay connector 6 includes the intrusion detection circuit 12.

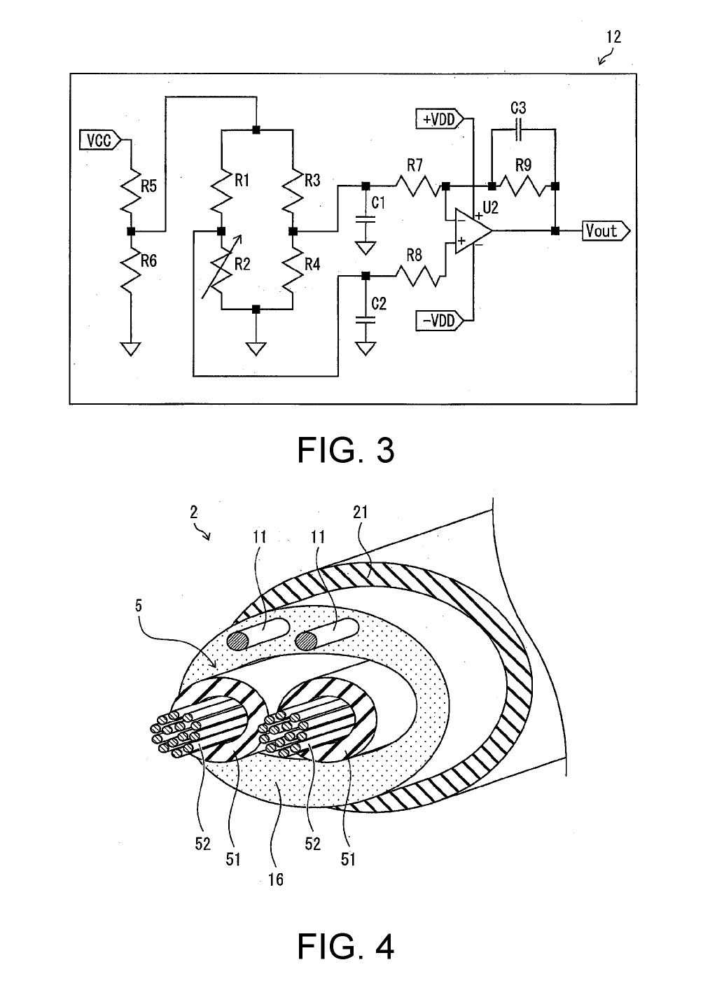

FIG. 3 is a diagram showing an example of the intrusion detection circuit 12.

The intrusion detection circuit 12 detects a resistance value between the detection wires (the metal wires) 11 disposed in the cable 2, which will be described later. The intrusion detection circuit 12 converts a change in the resistance value between the detection wires 11 into an electric signal and outputs the electric signal to the CPU 13 through a cord 15. As shown in FIG. 3, for example, the intrusion detection circuit 12 may form a detection wire 11 at one end of a Wheatstone bridge of a signal amplification circuit. Further, the intrusion detection circuit 12 may output the resistance value as an amplified signal output voltage (a voltage value converted into the resistance value) to the CPU 13. The intrusion detection circuit 12 amplifies the resistance value between the detection wires 11 several hundreds to several thousands of times. Further, the Wheatstone bridge changes an amplification signal output voltage which is proportional to the resistance value (a degree of intrusion of the liquid) into an analog signal at a time at which the resistance value is detected. According to the above-described configuration, the CPU 13 can determine whether a liquid intrudes into the cable 2 regardless of an influence of a temperature, an electromagnetic noise, or the like.

Further, the relay connector 6 may include a calculation circuit different from the CPU 13 and a communication unit different from the communication unit 14. In the above-described configuration, the calculation circuit may output a detection result based on the amplification signal output voltage received from the intrusion detection circuit 12 to the external device 9 through the communication unit.

For example, the following problem may arise in a configuration in which a liquid intrusion detection switch is electrically short-circuited by an intruding liquid and a failure prediction signal is output. If the cross-sectional area of the short-circuit path is small and the short-circuit resistance of the path is a certain value (several MΩs) or more, it is impossible to obtain a sufficient current for operating the liquid intrusion detection switch to be turned on. For that reason, the failure prediction signal cannot be output.

Regarding a configuration having the Wheatstone bridge, the amplification signal output voltage of the intrusion detection circuit 12 is proportional to the resistance value (an insulation resistance value) in response to a degree of intrusion of the liquid and changes like an analog signal. For that reason, even for a high resistance of about several MO at the beginning of liquid intrusion, influence of noise can be suppressed and accurate liquid intrusion detection can be performed. Thus, the CPU 13 can reliably determine whether a liquid intrudes into the cable 2. For that reason, the CPU 13 can transmit a detection result of the resistance value to the external device 9 in response to the accurate detection result.

Additionally, the intrusion detection circuit 12 may convert the change in the resistance value between the detection wires 11 into an electric signal. Further, the signal amplification circuit is not particularly limited to the Wheatstone bridge.

Further, for example, a determination result in response to a signal of the CPU 13 (the calculation circuit) may be output to the external device 9 according to a communication method in which the amount of communication data is larger than that of binary data. As an example of the communication method, an IO-Link communication method can be exemplified.

The IO-Link is standardized under the name of “Single-drop Digital Communication Interface for Small Sensors and Actuators” (SDCI) in IEC61131-9, and is a standardization technique for communication between a master corresponding to a control device and a device corresponding to a sensor and an actuator.

According to the above-described configuration, for example, numerical data and the like can be communicated in comparison with a configuration in which only binary data such as on/off information can be communicated.

By using the IO-Link communication method, compatibility with external devices using the IO-Link communication method can be enhanced.

The cable 2 is connected to the sensor 1 at one end side of the cable 2. Further, the cable 2 is connected to the relay connector 6 at the other end side thereof different from the end connected to the sensor 1 in the cable 2. The cable 2 includes the cords 5, the cord 15, the (two) detection wires 11, and the like. The cord 5 is, for example, a cord to be connected to the power source of the sensor 1, a cord to ground the sensor 1, an output wire of the sensor 1, or the like. The detection wire 11 is formed of metal and is connected to the intrusion detection circuit 12. The cord 15 is used to transmit an electric signal output from the intrusion detection circuit 12 to the CPU 13.

FIG. 4 is a diagram showing an example of a cross-section of the cable 2. As shown in FIG. 4, the cable 2 includes the detection wire 11, an outer sheath 21, the cord 5, a non-woven fabric 16 (an absorbing member), and the like. In addition, the cord 15 is omitted in FIG. 4.

The outer sheath 21 covers the entire cable 2 and prevents intrusion of a liquid into the cable 2 from the outside. As a material forming the outer sheath 21, a material excellent in water resistance performance or oil resistance performance such as vinyl chloride, urethane, and fluorine-based materials can be exemplified.

The non-woven fabric 16 is an absorbing member (a liquid absorbing body) which absorbs a liquid and is disposed to fill a gap between the cord 5 and the detection wire 11 inside the cable 2. Particularly, the non-woven fabric is disposed to fill a gap between the detection wires 11 and is disposed on the periphery of the detection wire 11 (to cover the detection wire 11). Instead of the non-woven fabric 16, for example, a water absorbing paper or resin having a high absorbing property may be used.

When a liquid intrudes into the cable 2, the non-woven fabric 16 absorbs the intruding liquid. For that reason, the resistance value between the detection wires 11 changes in response to a degree (amount) of the liquid absorbed by the non-woven fabric 16. That is, the liquid intruding into the cable 2 can be led to a space between the detection wires 11 by a structure in which the space between the detection wires 11 is filled by the non-woven fabric 16.

For example, in a configuration in which electrodes are formed on an electronic board inside the sensor and a resistance value between the electrodes is detected, there is a risk of the sensor failing when a structure which leads a liquid between the electrodes is provided.

According to the configuration in which the detection wires 11 are disposed inside the cable, there is no risk of a failure of the sensor 1 being caused even when the structure which leads a liquid between the detection wires 11 is provided.

Further, as shown in FIG. 4, the cord 5 includes an output wire 52 which outputs an output value from the sensor 1 and an inner sheath 51 which covers the entire output wire 52. The inner sheath 51 prevents intrusion of a liquid into the cord 5 from the outside. As a material forming the inner sheath 51, a material excellent in water resistance performance or oil resistance performance such as vinyl chloride, urethane, and fluorine-based materials can be exemplified.

The detection wires 11 are disposed between the outer sheath 21 and the inner sheath 51. According to the above-described configuration, the intrusion detection circuit 12 can detect a liquid intruding into the outer sheath 21.

### (Liquid Intrusion Detection Device 10)

As shown in FIG. 2A, the liquid intrusion detection device 10 includes the plurality of detection wires 11 which are disposed inside the cable 2 outputting an output value from a sensor measuring a single physical amount, the intrusion detection circuit 12 which detects a resistance value between the detection wires 11, and the CPU 13 and the communication unit 14 which transmit a resistance value detection result to the external device 9 in response to the resistance value detection result.

### (Intrusion of Liquid Into Sensor 1)

FIG. 2B is an enlarged view of a connection region R between the cable 2 and the sensor 1 shown in FIG. 2A. Here, an example in which a liquid intrudes into the sensor 1 will be described with reference to FIG. 2B. As shown in FIG. 2B, the cord 5 inside the sensor 1 is exposed from the outer sheath 21 and is connected to the communication unit 14 of the sensor 1 inside a charging resin 8. A ring type resin part 7 which is molded by polybutylene terephthalate (PBT) is disposed to cover a cross-section of the outer sheath 21 and a base of the exposed portion of the cord 5. The ring type resin part 7 prevents intrusion of a liquid into the sensor 1 along the outer sheath 21 and the cord 5. An arrow shown in FIG. 2B indicates a liquid intrusion path toward the sensor 1.

When a material with high chemical stability such as a fluorine-based material is used for the outer sheath 21 and the inner sheath 51, adhesive strength to the parts of the connection portion of the sensor 1 with the outer sheath 21 and the inner sheath 51 decreases. For that reason, a liquid intrudes from a gap formed by deterioration in the adhesive strength at a stage earlier than the deterioration of the outer sheath 21 and the inner sheath 51.

Further, in an environment in which a highly permeable water-soluble coolant oil, a chemical, or the like is scattered on the sensor 1, a liquid gradually intrudes from a gap between the ring type resin part 7 and the cable 2 and the cord 5. Generally, the sensor 1 is provided in the vicinity of a measurement target. For that reason, an installation environment of the sensor 1 becomes an environment in which a liquid is scattered. Thus, an installation environment of the relay connector 6 is more stable than the installation environment of the sensor 1. Thus, the intrusion of the liquid into the sensor 1 more easily occurs in the connection region between the sensor 1 and the cable 2 in comparison to a connection region between the relay connector 6 and the cable 2.

According to the configuration of the embodiment, it is possible for the user to be notified of the detection result in response to the resistance value between the detection wires 11. Thus, the user can recognize whether the liquid intrudes into the cable 2.

As for the intrusion of the liquid into the sensor 1, the liquid first intrudes into the cable and then intrudes into the sensor 1 in many cases. For that reason, the user can recognize the intrusion of the liquid into the sensor 1 and a failure of the sensor which may happen in the future in advance by checking whether the liquid intrudes into the cable 2.

For example, in comparison to a configuration in which electrodes are formed on an electronic board inside the sensor 1 and a resistance value between the electrodes is detected, it is possible to ensure a sufficient time for the user to take measures against the failure of the sensor 1 before the liquid intrudes into the sensor 1 and the sensor fails. For that reason, the user can recognize the sensor in which the liquid intrudes into the cable 2 as a replacement target sensor. Then, the user can prepare a preventive maintenance plan for replacing the sensor and stop a production line having the sensor for the maintenance. Thus, the user can avoid a sudden stoppage of the production line due to a failure of the sensor caused by the intrusion of the liquid.

As described above, the intrusion detection circuit 12 is disposed inside the relay connector 6. That is, the intrusion detection circuit 12 is connected to the detection wire 11 at the end side of the cable 2 opposite to the end side of the cable 2 connected to the sensor 1.

According to the above-described configuration, the detection wire 11 and the intrusion detection circuit 12 are connected to each other at the end of the cable opposite to the connection side between the sensor and the cable. For that reason, it is possible to prevent the intrusion of the liquid into the sensor along the detection wire 11 in comparison to a configuration in which the intrusion detection circuit 12 is disposed inside the sensor.

Further, the liquid may intrude into the connection region between the cable 2 and the relay connector 6 when a liquid scattering environment is the same between the installation position of the sensor 1 and the installation position of the relay connector 6. For that reason, a length of the cable 2 may be adjusted to have a better liquid scattering environment at the installation position of the relay connector 6 (to separate the installation position of the relay connector 6 from the installation position of the sensor 1.

Additionally, the intrusion detection circuit 12 may be connected to the detection wire 11 at the end side of the cable 2 connected to the sensor 1.

### (Main Configuration and Process Flow of Liquid Intrusion Detection Device 10)

FIG. 1 is a block diagram showing a main configuration of the liquid intrusion detection device 10. As shown in FIG. 1, the liquid intrusion detection device 10 includes the detection wire 11, the intrusion detection circuit 12, the CPU 13, and the communication unit 14. The CPU 13 includes a liquid intrusion determination unit 131. Since the detection wire 11, the intrusion detection circuit 12, and the communication unit 14 have been described above in detail, descriptions thereof will be omitted herein.

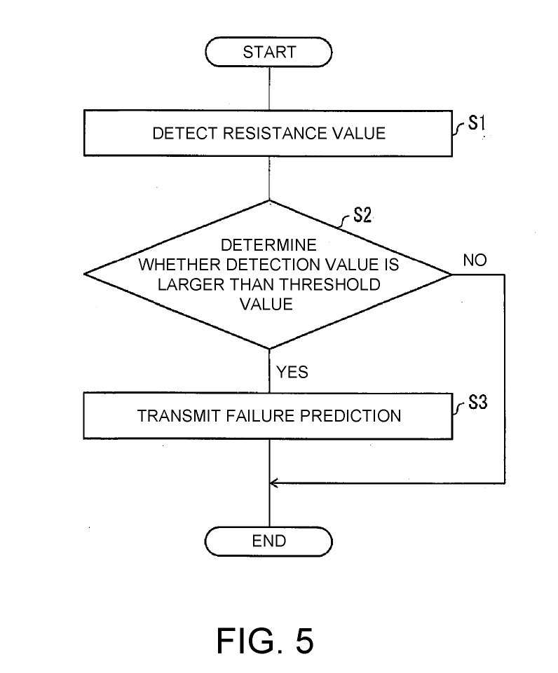

FIG. 5 is a flowchart showing an example of a process of the liquid intrusion detection device 10. A detailed process of the liquid intrusion determination unit 131 of the CPU 13 will be described with reference to FIG. 5. As shown in FIG. 5, the intrusion detection circuit 12 detects a resistance value between the detection wires 11 (s1) and transmits an output voltage value to the liquid intrusion determination unit 131.

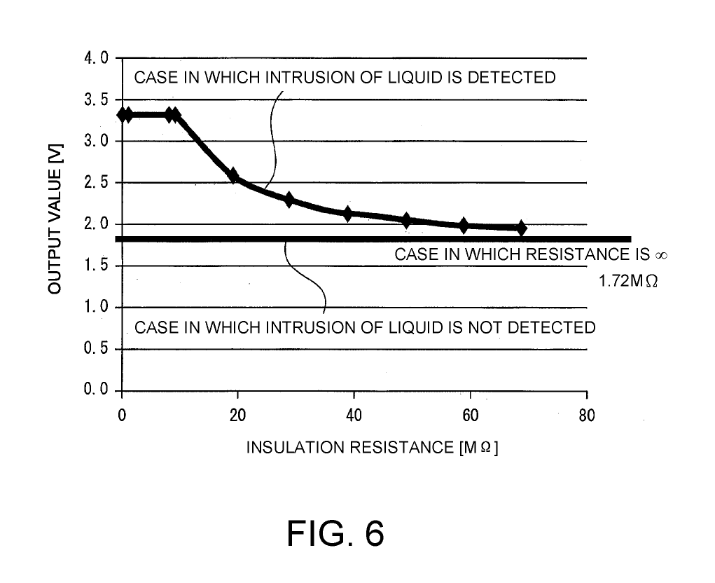

FIG. 6 is a diagram showing an example of a correlation between the output voltage value (the output value) of the intrusion detection circuit 12 and an insulation resistance value between the detection wires 11. As shown in FIG. 6, when a liquid intrudes into the cable 2, the insulation resistance value decreases and the output voltage value of the intrusion detection circuit 12 increases.

The liquid intrusion determination unit 131 receives the output voltage value and calculates an amount of change of the output voltage value of the intrusion detection circuit 12 in the case in which intrusion of a liquid is not detected. The liquid intrusion determination unit 131 determines whether the amount of change of the output voltage value is larger than a predetermined determination reference (a threshold value) (S2).

When the amount of change of the output voltage value is larger than the threshold value (YES in S2), the liquid intrusion determination unit 131 transmits a signal predicting a failure of the sensor 1 to (notifies a failure prediction result to) the external device 9 through the communication unit 14 (S3) and ends the process. When the amount of change of the output voltage value is smaller than or equal to the threshold value (NO in S2), the process ends.

That is, the liquid intrusion determination unit 131 sets a degree of intrusion of a liquid in the cable 2 as an amount of deterioration of the sensor 1 and predicts a failure of the sensor 1.

According to the above-described configuration, a user can recognize a failure of the sensor 1 before the sensor 1 fails due to the notification of the failure.

Additionally, in the embodiment, an example of a configuration in which the liquid intrusion detection device 10 transmits a failure prediction result of the sensor 1 to the external device 9 has been described. Meanwhile, the liquid intrusion detection device 10 may have the following configuration. For example, the liquid intrusion detection device 10 transmits an output voltage value of the intrusion detection circuit 12, a value of insulation resistance detected by the intrusion detection circuit 12, and a quantitative numerical value indicating a degree of intrusion of a liquid in the cable 2 to the external device 9. The external device 9 predicts a failure of the sensor 1 from the values (the output voltage value of the intrusion detection circuit 12, the value of the insulation resistance detected by the intrusion detection circuit 12, and the quantitative numerical value indicating the degree of intrusion of the liquid in the cable 2) received from the liquid intrusion detection device 10.

### (Application of Software)

A control block (particularly, the liquid intrusion determination unit 131) of the liquid intrusion detection device 10 may be realized by a logic circuit (hardware) formed on an integrated circuit (an IC chip) or the like or may be realized by software using a CPU (Central Processing Unit).

In the latter case, the liquid intrusion detection device 10 includes a CPU which executes an instruction of a program corresponding to software realizing functions, a ROM (Read Only Memory) or a storage device (which is also referred to as a “storage medium”) which stores the program and various pieces of data to be readable by a computer (or a CPU), a RAM (Random Access Memory) which develops the program, and the like. Then, when the computer (or the CPU) reads the program from the storage medium and executes the program, effects of an embodiment of the disclosure are achieved. As the storage medium, a “non-temporary tangible medium,” for example, a tape, a disk, a card, a semiconductor memory, a programmable logic circuit, or the like can be used. Further, the program may be supplied to the computer via a transmission medium (a communication network, a broadcast wave, or the like) capable of transmitting the program. Additionally, one embodiment of the disclosure can also be realized in the form of a data signal which is embedded in a carrier wave and in which the program is embodied by electronic transmission.

The disclosure is not limited to the above-described embodiment, various modifications can be made within the scope of claims, and embodiments obtained by an appropriate combination of technical means respectively disclosed in different embodiments are also included in the technical scope of the disclosure.

What is claimed is:

1. A liquid intrusion detection device comprising:
a plurality of metal wires which are disposed inside a cable outputting an output value from a sensor measuring a single physical amount;
a resistance value detection unit which detects a resistance value between the metal wires; and
a communication unit which transmits a resistance value detection result to an external device in response to the resistance value detection result.

2. The liquid intrusion detection device according to claim 1,
wherein the resistance value detection unit is connected to the plurality of metal wires at an end side of the cable opposite to an end side of the cable connected to the sensor.

3. The liquid intrusion detection device according to claim 2,
wherein the cable includes an outer sheath covering the cable and an inner sheath covering an output wire outputting an output value from the sensor disposed inside the cable, and
wherein the metal wires are disposed between the outer sheath and the inner sheath.

4. The liquid intrusion detection device according to claim 3,
wherein the cable includes an absorbing member that absorbs a liquid on a periphery of the metal wire.

5. The liquid intrusion detection device according to claim 1,
wherein a resistance value detection circuit detecting the resistance value between the metal wires includes a Wheatstone bridge corresponding to a signal amplification circuit.

6. The liquid intrusion detection device according to claim 1,
wherein the sensor is a proximity sensor.

7. The liquid intrusion detection device according to claim 1,
wherein the communication unit transmits the resistance value detection result to the external device by a communication method in which an amount of communication data is larger than that of binary data.
